(19) United States
(12) Patent Application Publication
(10) Pub. No.: US 2019/0230607 A1
(43) Pub. Date: Jul. 25, 2019

(54) METHOD AND TERMINAL FOR DETERMINING TRANSMISSION POWER OF UPLINK CHANNEL

(71) Applicant: LG ELECTRONICS INC., Seoul (KR)

(72) Inventors: Jaehoon CHUNG, Seoul (KR); Kilbom LEE, Seoul (KR)

(73) Assignee: LG ELECTRONICS INC., Seoul (KR)

(21) Appl. No.: 16/312,967

(22) PCT Filed: Jun. 22, 2017
(86) PCT No.: PCT/KR2017/006566

§ 371 Date: Dec. 21, 2018

Related U.S. Application Data
(60) Provisional application No. 62/353,042, filed on Jun. 22, 2016.
(60) Provisional application No. 62/353,576, filed on Jun. 23, 2016.
(60) Provisional application No. 62/354,824, filed on Jun. 27, 2016.
(60) Provisional application No. 62/355,835, filed on Jun. 28, 2016.
(60) Provisional application No. 62/357,345, filed on Jun. 30, 2016.

(51) Int. Cl. H04W 52/36; H04W 52/14; H04L 25/02; H04L 5/00; H04W 72/04; H04L 1/16

(52) U.S. Cl. CPC H04W 52/367; H04W 52/146; H04L 25/0226; H04L 1/1664; H04W 72/0473; H04W 72/0446; H04L 5/0051

(57) ABSTRACT

A disclosure of the present specification provides a method for determining transmission power of an uplink channel. The method may comprise the steps of: selecting the maximum transmission power from among transmission power of multiple uplink channels transmitted to a specific serving cell in a first subframe; and when a first uplink channel has transmission power lower than the maximum transmission power and the transmission power is smaller than the difference between the maximum transmission power and a first threshold, determining boosting of the transmission power of the first uplink channel. Here, the multiple uplink channels may comprise one or more of an uplink data channel, an uplink control channel, and an uplink reference signal.

### BACKGROUND OF THE INVENTION

### Field of the Invention

The present invention relates to a next generation mobile communication.

### Related Art

With the success of long term evolution (LTE)/LTE-A (LTE-Advanced) for the 4th generation mobile communication, more interest is rising to the next generation, i.e., 5th generation (also known as 5G) mobile communication and extensive research and development are being carried out accordingly.

It is expected to realize a data service with a minimum speed of 1 Gbps in a next-generation mobile communication, i.e., 5G mobile communication.

A subframe (or slot) as a unit of transmission time interval (TTI) which is under discussion for the 5G mobile communication may differ from the existing LTE/LTE-A subframe. Specifically, a front portion symbol of the subframe (or slot) for the 5G mobile communication may be used for a downlink (DL) control channel, and an end portion symbol of the subframe (or slot) may be used for an uplink (UL) control channel In addition, a middle portion symbol of the subframe may be used for a UL data channel or a DL data channel.

However, when the middle portion symbol of the subframe is used as the UL data channel, the subframe may be called a UL subframe. In this case, when the UL control channel is transmitted in the end portion symbol of the subframe, transmission power may vary for each symbol. Accordingly, there is a problem in that a peak-to-average power ratio (PAPR) may increase.

### SUMMARY OF THE INVENTION

Accordingly, a disclosure of the present specification has been made in an effort to solve the aforementioned problem.

In order to achieve the aforementioned purpose, a disclosure of the present specification provides a method of determining transmission power of an uplink channel. The method may comprise: selecting maximum transmission power from among transmission power for multiple uplink channels transmitted to any serving cell in a first subframe; and when transmission power for a first uplink channel having lower transmission power than the maximum transmission power is less than a difference between the maximum transmission power and a first threshold, determining boosting of transmission power of the first uplink channel. The multiple uplink channels may comprise one or more of an uplink data channel, an uplink control channel, and an uplink reference signal.

A transmission power for the first channel is determined to be boosted by the difference between the maximum transmission power and the first threshold.

The uplink data channel may be a physical uplink shared channel (PUSCH). The uplink control channel may be a physical uplink control channel (PUCCH). The uplink reference signal may be a sounding reference signal (SRS).

The first threshold may be received through an uplink signal or is predetermined or is determined by a terminal.

The method may further comprise: when uplink carrier aggregation is configured, scaling down transmission power of one or more uplink channels for each cell if a total sum of transmission power of multiple uplink channels for multiple cells in the first subframe is greater than total configured maximum output power of a terminal.

If the total sum of transmission power of the uplink control channels for the multiple cells may be less than the total configured maximum output power of the terminal, the one or more uplink channels to be scaled down comprise the uplink data channel and the uplink reference signal.

If the total sum of transmission power of the uplink control channels for the multiple cells may be greater than the total configured maximum output power of the terminal, the one or more uplink channels to be scaled down comprise the uplink control channel and the uplink data channel.

In order to achieve the aforementioned purpose, a disclosure of the present specification provides a terminal for determining transmission power of an uplink channel The terminal may comprise: a transceiver; and a processor controlling the transceiver, wherein the processor is configured to: select maximum transmission power from among transmission power for multiple uplink channels transmitted to any serving cell in a first subframe. When transmission power for a first uplink channel having lower transmission power than the maximum transmission power is less than a difference between the maximum transmission power and a first threshold, determine boosting of transmission power of the first uplink channel The multiple uplink channels may comprise one or more of an uplink data channel, an uplink control channel, and an uplink reference signal.

According to the disclosure of the present invention, the problem of the conventional technology described above may be solved.

### BRIEF DESCRIPTION OF THE DRAWINGS

FIG. 1 is a wireless communication system.

FIG. 2 illustrates a structure of a radio frame according to FDD in 3GPP LTE.

FIG. 3 shows a process of UL transmission.

FIG. 4 shows an example of a subframe type in NR.

FIG. 5 is an exemplary diagram showing self-contained subframes (or slots) according to a carrier aggregation situation in a next-generation mobile communication system.

FIG. 6A and FIG. 6B show a criterion of determining a power scaling parameter according to the proposal 3.

FIG. 7 is an exemplary diagram showing a method of applying power scaling according to the proposal 4.

FIG. 8 is a flowchart showing a procedure according to the embodiment 3.

FIG. 9 is a block diagram showing a wireless communication system for implementing a disclosure of the present specification.

### DESCRIPTION OF EXEMPLARY EMBODIMENTS

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present invention includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present invention, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, ‘user equipment (UE)’ may be stationary or mobile, and may be denoted by other terms such as device, wireless device, terminal, MS (mobile station), UT (user terminal), SS (subscriber station), MT (mobile terminal) and etc.

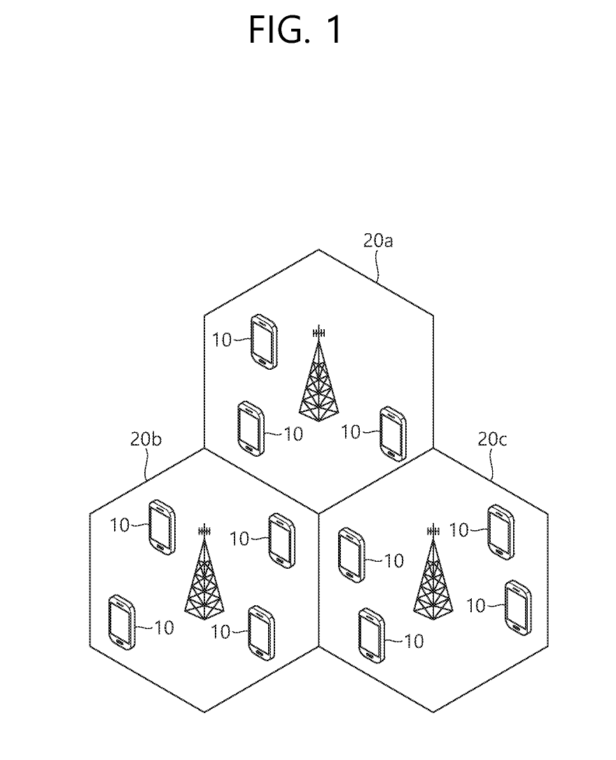

FIG. 1 illustrates a wireless communication system.

As seen with reference to FIG. 1, the wireless communication system includes at least one base station (BS) 20. Each base station 20 provides a communication service to specific geographical areas (generally, referred to as cells) 20a, 20b, and 20c. The cell can be further divided into a plurality of areas (sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Hereinafter, the LTE system will be described in detail.

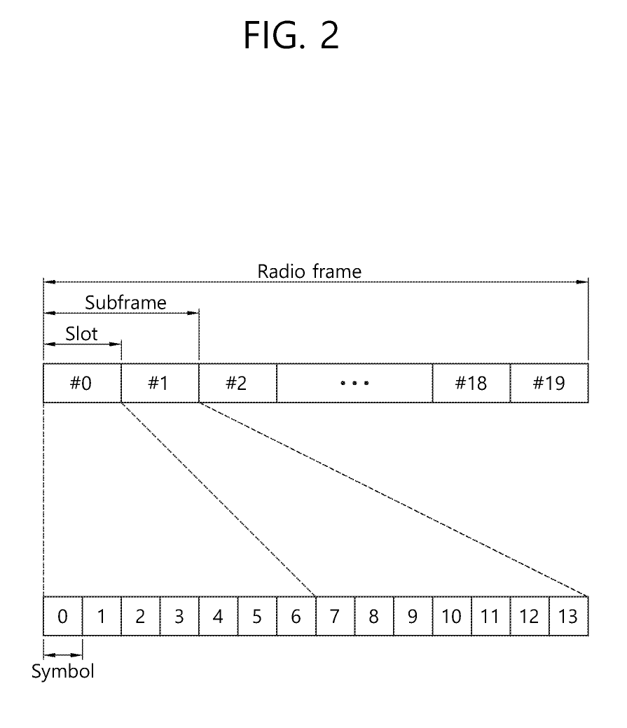

FIG. 2 shows a downlink radio frame structure according to FDD of 3rd generation partnership project (3GPP) long term evolution (LTE).

The radio frame of FIG. 2 may be found in the section 5 of 3GPP TS 36.211 V10.4.0 (2011 December) “Evolved Universal Terrestrial Radio Access (E-UTRA); Physical Channels and Modulation (Release 10)”.

The radio frame includes 10 sub-frames indexed 0 to 9. One sub-frame includes two consecutive slots. Accordingly, the radio frame includes 20 slots. The time taken for one sub-frame to be transmitted is denoted TTI (transmission time interval). For example, the length of one sub-frame may be 1 ms, and the length of one slot may be 0.5 ms.

The structure of the radio frame is for exemplary purposes only, and thus the number of sub-frames included in the radio frame or the number of slots included in the sub-frame may change variously.

One slot includes N_{RB} resource blocks (RBs) in the frequency domain. For example, in the LTE system, the number of resource blocks (RBs), i.e., N_{RB}, may be one from 6 to 110.

The resource block is a unit of resource allocation and includes a plurality of sub-carriers in the frequency domain. For example, if one slot includes seven OFDM symbols in the time domain and the resource block includes 12 sub-carriers in the frequency domain, one resource block may include 7×12 resource elements (REs).

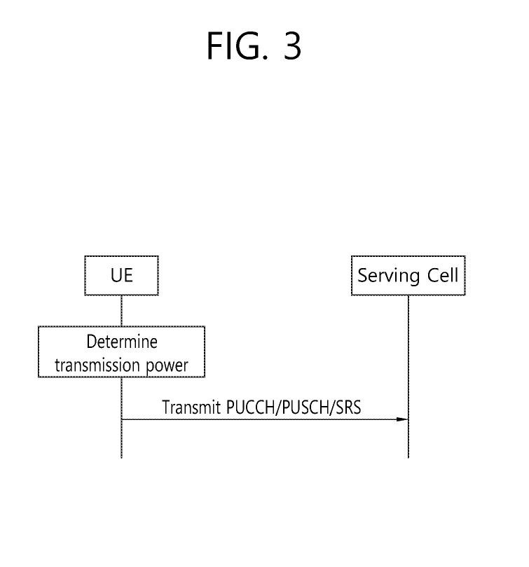

FIG. 3 shows a process of UL transmission.

Referring to FIG. 3, a UE first determines transmission power, and thereafter performs uplink transmission, for example, transmits a physical uplink control channel (PUCCH), a physical uplink shared channel (PUSCH), or a sounding reference signal (SRS), with the determined transmission power.

First, the transmission power of the PUSCH may be determined as follows.

If the UE transmits only the PUSCH without simultaneous transmission of the PUCCH for a serving cell c, UE transmission power P_{PUSCH,c}(i) in a subframe i for the serving cell c may be determined as follows.

$$[ Equation 1 ] \\ {P}_{PUSCH , c} ( i ) = min \{ \begin{matrix}{P}_{CMAX , c} ( i ) , \\ 10 {log}_{10} ( {M}_{PUSCH , c} ( i ) ) + {P}_{0 \_PUSCH , c} ( j ) + {α}_{c} ( j ) \cdot {PL}_{c} + {Δ}_{TF , c} ( i ) + {f}_{c} ( i )\end{matrix} \} \qquad$$

Otherwise, if the UE simultaneously transmits the PUCCH and the PUSCH for the serving cell c, the UE transmission power P_{PUSCH,c}(i) in the subframe i for the serving cell c may be determined as follows.

$$[ Equation 2 ] \\ {P}_{PUSCH , c} ( i ) = min \{ \begin{matrix}10 {log}_{10} ( {\hat{P}}_{CMAX , c} ( i ) - {\hat{P}}_{PUCCH} ( i ) ) , \\ 10 {log}_{10} ( {M}_{PUSCH , c} ( i ) ) + {P}_{0 \_PUSCH , c} ( j ) + {α}_{c} ( j ) \cdot {PL}_{c} + {Δ}_{TF , c} ( i ) + {f}_{c} ( i )\end{matrix} \} \qquad$$

Parameters in Equations 1 and 2 above are as follows.
P_{CMAX,c}(i) is UE transmission power configured in the subframe i for the serving cell c.
\hat{P}_{CMAX,c}(i) is a linear value of P_{CMAX,c}(i).
\hat{P}_{PUCCH}(i) is a linear value of P_{PUCCH}(i).
M_{PUSCH,c}(i) is a bandwidth of PUSCH resource assignment for the serving cell c in the subframe i, and is expressed as the number of resource blocks (RBs).
P_{O}_{_}_{PUSCH,c}(j) is a parameter expressed as a sum of P_{O}_{_}_{NORMINAL}_{_}_{PUSCH,c}(j) provided from a higher layer with respect to j=0 and j=1 and P_{O}_{_}_{UE}_{_}_{PUSCH,c}(j) provided from the higher layer with respect to j=0 and j=1.
α_{c}(j) is any one of 0, 0.4, 0.5, 0.6, 0.7, 0.8, 0.9, and 1.
PL_{c} is a downlink path-loss estimation value calculated by the UE for the serving cell c, and is expressed in dB.
Δ_{TF,c}(i) is as follows.

Δ_{TF,c}(i)=10log₁₀((2^{BPRE·K}ₛ−1)·β_{offset}^{PUSCH}) for Kₛ=1.25.

Δ_{TF,c}(i)=0 for Kₛ=0.

Herein, Kₛ is a parameter provided by the higher layer. BPRE=O_{CQI}/N_{RE}. O_{CQI} is the number of CQI/PMI bits including a CRC bit. N_{RE} is the number of resource elements.
β_{offset}^{PUSCH}=β_{offset}^{CQI}
δ_{PUSCH,c} is a correction value.
f_{c}(i) is as follows.

f_{c}(i)=f_{c}(i−1)+δ_{PUSCH,c}(i-K_{PUSCH})

f_{c,1}(i)=f_{c,2}(i−1)+δ_{PUSCH,c}(i-K_{PUSCH})

Meanwhile, transmission power of the PUCCH may be determined as follows.

If the serving cell c is a primary cell (hereinafter, Pcell) in carrier aggregation (hereinafter, CA) and uses a PUCCH format 1/1a/1b/2/2a/2b/3, UE transmission power P_{PUCCH} for PUCCH transmission to the serving cell c in the subframe i may be expressed by the following equation.

$$[ Equation 3 ] \\ {P}_{PUCCH} ( i ) = min \{ \begin{matrix}{P}_{CMAX , c} ( i ) , \\ {P}_{0 \_PUCCH} + {PL}_{c} + h ( {n}_{CQI} , {n}_{HARQ ,} {n}_{SR} ) + {Δ}_{F\_PUCCH} ( F ) + {Δ}_{T \times D} ( {F}^{′} ) + g ( i )\end{matrix} \} [ dBm ] \qquad$$

However, if the serving cell c is a secondary cell (hereinafter, Scell) in CA, and uses a PUCCH format 4/5, UE transmission power P_{PUCCH} for PUCCH transmission to the serving cell c in the subframe i may be expressed as follows.

$$[ Equation 4 ] \\ {P}_{PUCCH} ( i ) = min \{ \begin{matrix}{P}_{CMAX , c} ( i ) , \\ {P}_{0 \_PUCCH} + {PL}_{c} + 10 {log}_{10} ( {M}_{PUCCH , c} ( i ) ) + {Δ}_{F\_PUCCH} ( F ) + g ( i )\end{matrix} \} [ dBm ] \qquad$$

Parameters in Equations 3 and 4 above are as follows.
P_{CMAX,c}(i) is UE transmission power configured in the subframe i for the serving cell c.
Δ_{F}_{_}_{PUCCH}(F) is defined in a higher layer (RRC).
Δ_{TxD}(F′) is as follows. If the UE is configured by the higher layer to transmit a PUCCH for two antenna ports, a value Δ_{TxD}(F′) for each PUCCH format F′ is provided by the higher layer. Otherwise, Δ_{TxD}(F′)=0 without exception.
h(n_{CQI},n_{HARQ},n_{SR}) has a different value for each PUCCH format. Herein, n_{CQI} denotes the number of bits of channel quality information (CQI). In addition, if a scheduling request (SR) is configured in the subframe i and there is no SR configuration in any transmission block related to UL-SCH of the UE, n_{SR}=1, and otherwise, n_{SR}=0. If the UE is configured in one serving cell, n_{HARQ} is the number of HARQ-ACK bits transmitted in the subframe i. h(n_{CQI},n_{HARQ},n_{SR})=0 for the PUCCH format 1/1a/1b. If the UE is configured in one or more serving cells for the PUCCH format 1 b of channel selection, h(n_{CQI},n_{HARQ},n_{SR})=(n_{HARQ}−1)/2, and otherwise, h(n_{CQI},n_{HARQ},n_{SR})=0. For a PUCCH format 2/2a/2b and a normal cyclic prefix, if n_{CQI} is greater than or equal to 4, h(n_{CQI},n_{HARQ},n_{SR})=10log₁₀(n_{CQI}/4), and otherwise, h(n_{CQI},n_{HARQ},n_{SR})=0. For the PUCCH format 2 and an extended cyclic prefix, if “n_{CQI}+n_{HARQ}” is greater than or equal to 4, h(H_{CQI},n_{HARQ},n_{SR})=10log₁₀((n_{CQI}+n_{HARQ})/4), and otherwise, h(H_{CQI},n_{HARQ},n_{SR})=0. For a PUCCH format 3, if the UE is configured by the higher layer to transmit a PUCCH in two antenna ports or if the UE is configured to transmit HARQ-ACK/SR of 11 bits, h(n_{CQI},n_{HARQ},n_{SR})=(n_{HARQ}+n_{SR}−1)/3, and otherwise, h(H_{CQI},n_{HARQ},n_{SR})=(n_{HARQ}+H_{SR}−1)/2.
P_{O}_{_}_{PUCCH} is a parameter composed of a sum of a parameter P_{O}_{_}_{NOMINAL}_{_}_{PUCCH} and parameter P_{O}_{_}_{UE}_{_}_{PUCCH} provided by the higher layer.

Finally, transmission power of the SRS may be determined as follows.

UE transmission power P_{SRS} for the SRS transmitted in the subframe i for the serving cell c may be determined as follows.

P_{SRS,c}(i)=min{P_{CMAX,c}(i),P_{SRS}_{_}_{OFFSET,c}(m)+10log₁₀(M_{SRS,c})+P_{O}_{_}_{PUSCH,c}(j)+α_{c}(j)·PL_{c}+f_{c}(i)} [Equation 5]

Parameters in Equation 5 above are as follows.
P_{CMAX,c}(i) is UE transmission power configured in the subframe i for the serving cell c.
P_{SRS}_{_}_{OFFSET,C}(m) is a value semi-statically configured by a higher layer with respect to m=0 and m=1 for the serving cell c.
M_{SRS,c} is a bandwidth of PUSCH resource assignment for the serving cell c in the subframe i, and is expressed as the number of resource blocks (RBs).
f_{c}(i) denotes a current PUCCH power control adjustment state for the serving cell c.
P_{O}_{_}_{PUSCH,c}(j) and α_{c}(j) are the same as those described above for PUSCH transmission power.

### Next-Generation Mobile Communication Network

With the successful commercialization of mobile communication based on the 4G LTE/IMT (international mobile telecommunications) standard, research on the next-generation mobile communication (5G mobile communication) is underway. A 5G mobile communication system aims at higher capacity than the current 4G LTE, and can increase density of mobile broadband users and support device to device (D2D), high reliability, and machine type communication (MTC). The 5G research and development also aim at lower latency and lower battery consumption than a 4G mobile communication system to implement better Internet of things. A new radio access technology (new RAT or NR) may be proposed for the 5G mobile communication.

In the NR, it can be considered that a DL subframe is used in reception from a BS and a UL subframe is used in transmission to the BS. This approach may be applied to paired spectra and unpaired spectra. One pair of spectra implies that two carrier spectra are included for DL and UL operations. For example, in one pair of spectra, one carrier may include a DL band and a UL band which are paired with each other.

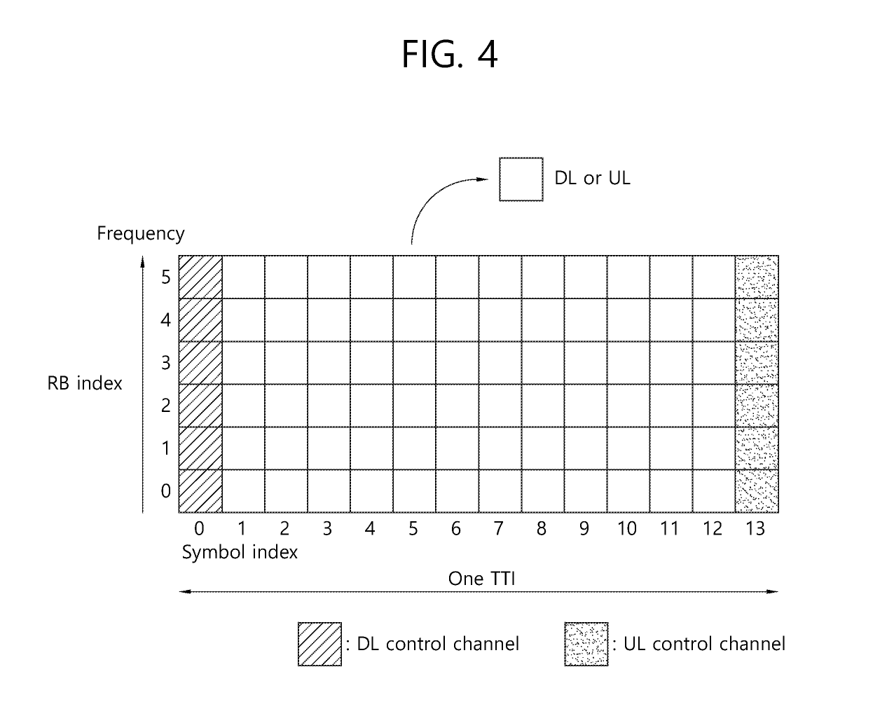

FIG. 4 shows an example of a subframe type in NR.

A transmission time interval (TTI) of FIG. 4 may be referred to as a subframe or slot for NR (or new RAT). A subframe (or slot) of FIG. 4 may be used in a TDD system of NR (or new RAT) to minimize data transmission latency. As shown in FIG. 4, the subframe (or slot) includes 14 symbols, similarly to the current subframe. A front portion symbol of the subframe (or slot) may be used for a DL control channel, and an end portion symbol of the subframe (or slot) may be used for a UL control channel The remaining symbols may be used for DL data transmission or UL data transmission. According to such a subframe (or slot) structure, DL transmission and UL transmission may be sequentially performed in one subframe (or slot). Accordingly, DL data may be received within the subframe (or slot), and a UL acknowledgement (ACK/NACK) may be transmitted within the subframe (or slot). The subframe (or slot) structure may be referred to as a self-contained subframe (or slot). The use of the subframe (or slot) structure has an advantage in that a time required to transmit data which has been erroneously received is reduced, thereby minimizing a final data transmission latency. In the self-contained subframe (or slot) structure, a time gap may be required in a process of transitioning from a transmission mode to a reception mode or from the reception mode to the transmission mode. For this, some OFDM symbols may be set to a guard period (GP) when switching from DL to UL in the subframe structure.

### Disclosures of the Present Specification

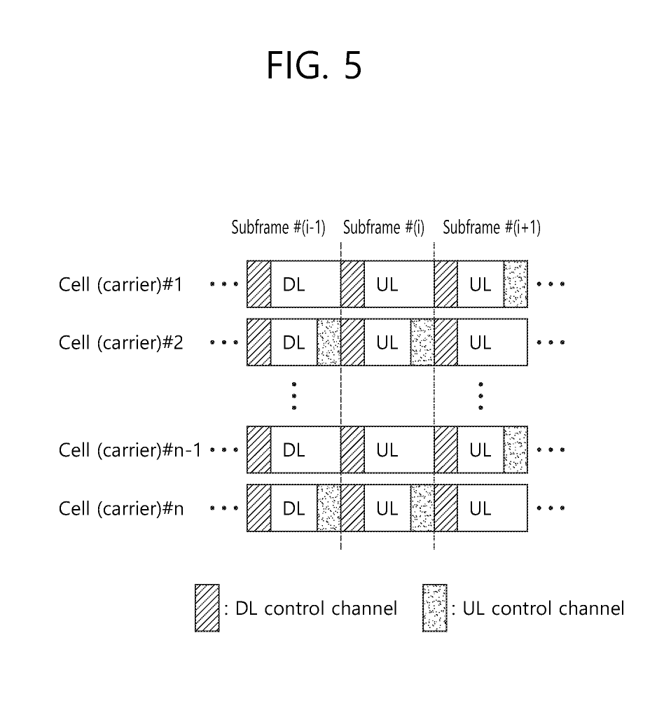

As described above, the self-contained subframes (or slots) of FIG. 4 may also be introduced in the next-generation mobile communication. In this case, a situation where carrier aggregation is also used is shown in FIG. 5.

FIG. 5 is an exemplary diagram showing self-contained subframes (or slots) according to a carrier aggregation situation in a next-generation mobile communication system.

Referring to FIG. 5, it is shown an example in which all of multiple cells (i.e., multiple carriers) configure a subframe i-1 as a DL subframe, and configure a subframe i as a UL subframe. As such, it may be considered in the next-generation mobile communication (i.e., 5G) that all of carriers have the same DL/UL configuration in order to reduce complexity.

Meanwhile, as shown in FIG. 5, a DL signal/channel and a UL signal/channel may be time-domain multiplexed in any subframe. In this case, whether a corresponding subframe is a DL subframe or a UL subframe is defined according to whether a channel to be transmitted is a DL channel or a UL channel In addition, irrespective of whether the corresponding subframe is defined as the UL subframe or the DL subframe, a UL control channel may be transmitted through a specific symbol predetermined in the corresponding subframe.

A disclosure of the present specification proposes methods for determining transmission power of a physical UL data channel transmitted in a UL subframe of FIG. 5.

### I. Proposals Based on the Disclosure of the Present Specification

### I-1. Proposal 1

First, transmission power of a UL data channel (e.g., PUSCH) and transmission power of a UL control channel (e.g., PUCCH) may be determined differently. However, assuming a situation where the UL data channel and the UL control channel are time-domain multiplexed within a UL subframe and thus are transmitted on different symbols, transmission power of a UE changes at a boundary between a symbol of the UL data channel and a symbol of the UL control channel. As such, the change in the transmission power of the UE at the symbol boundary may be undesirable in a sense that the UE drives a power amplifier. In particular, when the transmission power of the UE changes at the symbol boundary, there is a problem in that a peak-to-average power ratio (PAPR) increases.

Accordingly, the proposal 1 of the present specification proposes the followings.

A UE separately calculates transmission power (or power spectral density) to which an algorithm for calculating transmission power of a UL data channel is applied and transmission power (or power spectral density) to which an algorithm for calculating transmission power of a UL control channel is applied. In addition, the UE determines a maximum value of the two values as the transmission power, and transmits the UL data channel and the UL control channel by using the determined transmission power.

In this case, the algorithm for calculating the transmission power of the UL data channel may be a corresponding algorithm (i.e., Equation 1 or Equation 2) of 3GPP LTE/LTE-A or an improved algorithm as in the following embodiment. Likewise, the algorithm for calculating the transmission power of the UL control channel may be a corresponding algorithm (i.e., Equation 3 or Equation 4) of 3GPP LTE/LTE-A or an improved algorithm as in the following embodiment.

As a proposal modified from a method in which transmission power of a channel having smaller transmission power among the transmission method values of the two channels is increased to the maximum power value, a method of increasing lower transmission power may be applied so that a symbol transmission power difference of the two physical channels is not greater than a specific threshold. In this case, in the following embodiments 1, 1-A, and 1-B, instead of applying values configured for P_{xPUSCH,d}(i) and p_{d}^{aligned}(i) to power scaling as described below, regarding transmission power of a UL data channel and a UL control channel which are substantially time-domain multiplexed, if a difference of the two values is greater than any threshold, it is possible to apply a method of increasing transmission power of a channel having lower transmission power so that the difference of two transmission power values is equal to or less than the threshold.

As such, the method of increasing transmission power of the channel having lower transmission power may also be applied between the UL data channel and the SRS.

The threshold may be received from a BS through UE-specific signaling or cell-specific RRC signaling, or may be fixed to a specific value. Alternatively, the threshold may be arbitrarily determined by the UE on the basis of its capability.

### I-2. Proposal 2

As shown in FIG. 5, when CA is used, a channel transmitted by a UE on a UL subframe may be classified into the following types, and transmission power may be determined according to each of the types.

Type A: This is a case where a UL control channel and a UL data channel are time-domain multiplexed. In this case, transmission power (or power spectral density) may be determined according to the method of the aforementioned proposal 1.

Type B: This is a case where uplink control information (UCI) and UL data information are multiplexed at a level of a modulation symbol or a coded bit or a bit before being coded (for example, when UCI is piggybacked on a UL data channel through 3GPP LTE/LTE-A or its modification version). In this case, transmission power (or power spectral density) of a channel transmitted in a corresponding frame is directly used.

Type C: This is a case where a UL data channel is not time-domain multiplexed with a UL control channel and when UCI and UL data information are not multiplexed at a level of a modulated symbol or a coded bit or a bit before being coded (for example, when UCI is not piggybacked on a UL data channel through 3GPP LTE/LTE-A or its modification version). In other words, this is a case where only a UL data channel without UCI is transmitted alone in a corresponding subframe. In this case, transmission power (or power spectral density) of a channel transmitted in a corresponding subframe is determined.

When multiple channels based on the above three types are transmitted in a CA situation, if a sum of transmission power (or power spectral density) for each carrier (i.e., cell) is greater than maximum transmission power (or power spectral density) of a corresponding UE, it is possible to apply a method in which transmission power (or power spectral density) calculated for UL data channels of the type A and the type B is directly used, and transmission power (or power spectral density) calculated for a UL data channel of the type C is scaled with a weighting value in the range of 0 to 1, so that the sum of transmission power is maintained to maximum UE transmission power (or power spectral density) or a value less than that. The weighting value may be determined by the UE. According to a situation, the UE may set the weighting value to 0, so that the UL data channel of the type C is not transmitted.

### I-3. Proposal 3

As described above, in a situation where a UL data channel and a UL control channel are time-domain multiplexed within a UL subframe and thus are transmitted on different symbols, transmission power at a symbol on which the UL data channel is transmitted and transmission power at a symbol on which the UL control channel is transmitted may be calculated to be different from each other.

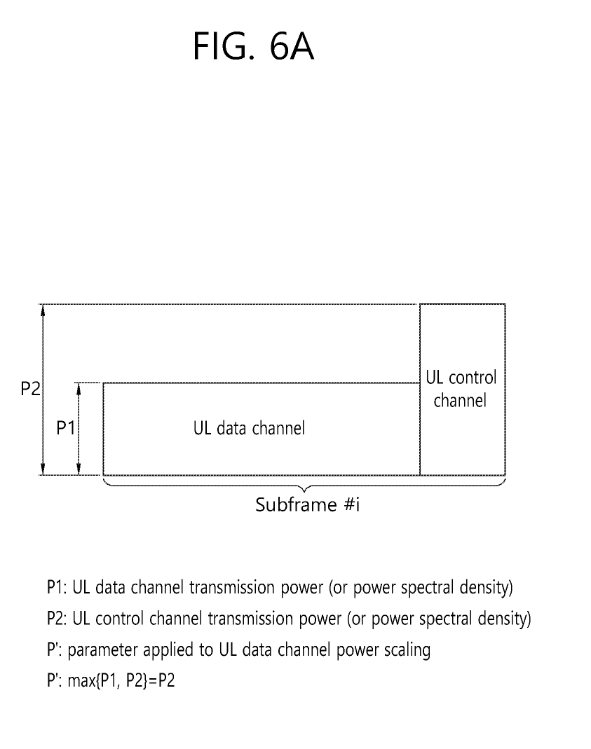

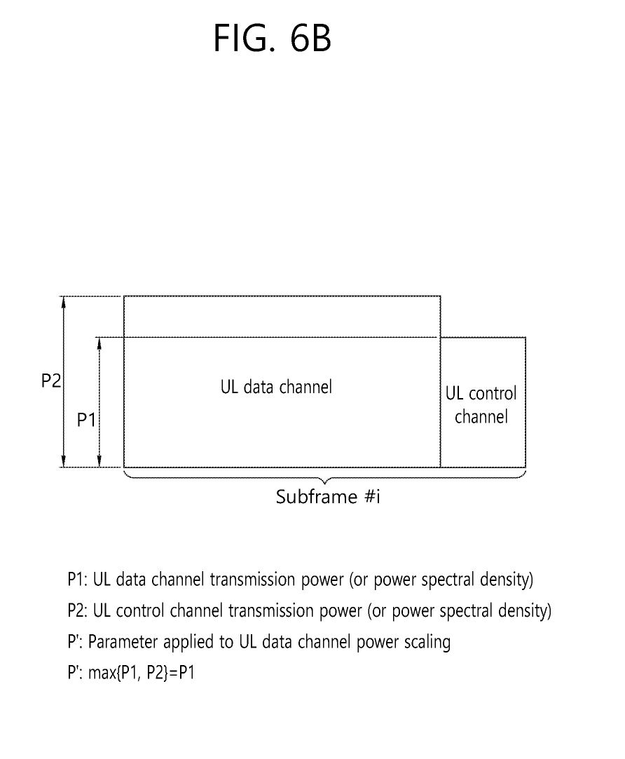

To solve this, the proposal 3 proposes to apply a single power scaling parameter. The single power scaling parameter may be determined based on transmission power having a greater value as shown in FIG. 6A and FIG. 6B. This may be described in detail as follows.

FIG. 6A and FIG. 6B show a criterion of determining a power scaling parameter according to the proposal 3.

As shown in FIG. 6A, if P1 denotes transmission power of a UL data channel in a subframe i and P2 denotes transmission power of a UL control channel where P2>P1, the scaling parameter is determined based on max{P1, P2}=P2. On the other hand, as shown in FIG. 6B, if P1 denotes transmission power of a UL data channel in a subframe i and P2 denotes transmission power of a UL control channel where P2 <P1, the scaling parameter is determined based on max {P1 , P2}=P1 .

Meanwhile, as an example of the modification of the proposal 3, the content of the proposal 1 may be applied so that a difference between transmission power of a symbol on which a UL data channel is transmitted and transmission power of a symbol on which a UL control channel is transmitted is within any threshold. That is, it is possible to apply a method of increasing lower transmission power so that the different of transmission power is not greater than or equal to the threshold. In this case, in the following embodiments 1, 1-A, and 1-B, instead of applying values configured for P_{xPUSCH,d}(i) and P_{d}^{aligned}(i) to power scaling as described below, regarding transmission power of a UL data channel and a UL control channel which are substantially time-domain multiplexed, when a difference of the two values is greater than any threshold, it is possible to apply a method of increasing transmission power of a channel having lower transmission power so that the difference of two transmission power values is equal to or less than the threshold.

### I-4. Proposal 4

As described above, in a situation where a UL data channel and a UL control channel are transmitted, unlike in the method of applying the proposal 1 to the proposal 3, it is possible to consider a method of applying power scaling to all UL data channels in the same subframe in a CA situation irrespective of whether UCI is piggybacked on the UL data channel.

Alternatively, when the UL data channel and the UL control channel are time-domain multiplexed in any carrier (or cell) in a CA situation, it is possible to apply a method of applying different power scaling between a symbol on which the UL control channel is transmitted and a symbol on which the UL control channel is not transmitted (i.e., a symbol on which the UL data channel is transmitted). This is described below as follows with reference to the drawings.

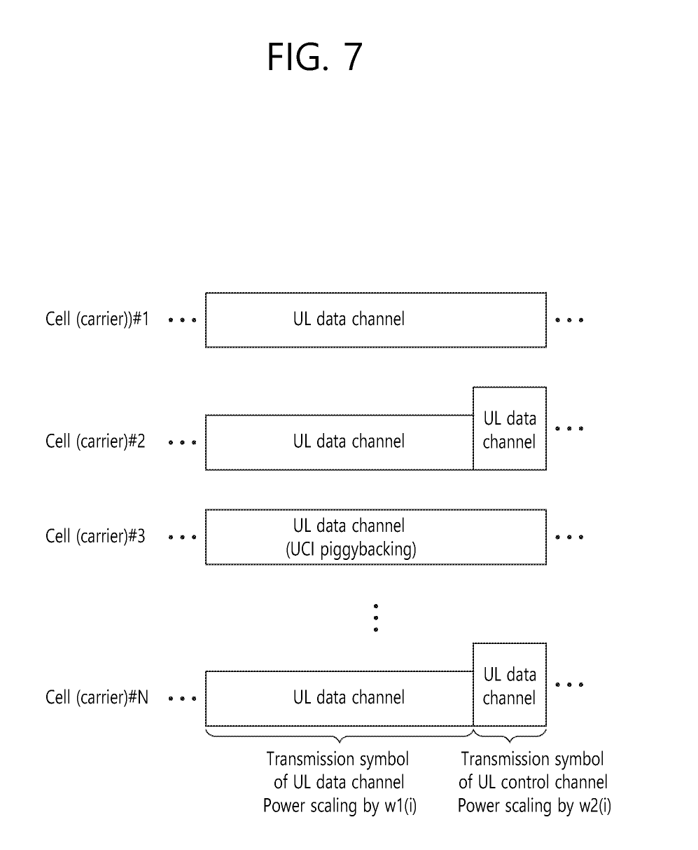

FIG. 7 is an exemplary diagram showing a method of applying power scaling according to the proposal 4.

As shown in FIG. 7, when CA is configured, a UL control channel may be transmitted (or transmission is scheduled from a BS) on at least one carrier on a subframe and thus the UL control channel may overlap on one subframe with respect to a UL data channel. If a sum of transmission power calculated for UL data channels of multiple carriers is greater than maximum allowed output power of a UE, the UE calculates a power value which exceeds an allowed limit for each symbol with respect to the total channels. In addition, the UE selects a maximum value from among the calculated exceeding power values on any symbol, and according to the selected maximum value, scales down this by equally applying w1(i) which is a first weighting factor or a first scaling factor to transmission power of the total channels so that a sum of transmission power of all channels is equal to or less than a UE allowed maximum output power limit.

Meanwhile, if the sum of transmission power calculated for multiple carriers on at least one symbol on which the UL control channel is transmitted is greater than the UE maximum allowed output power, transmission power of an SRS or a UL control channel is set to 0 on a corresponding symbol, and transmission power of the UL control channels is scaled down by applying w2(i) which is a second weighting factor or a second scaling factor.

On the other hand, if the sum of transmission power calculated for multiple carriers on at least one symbol on which the UL control channel is transmitted is less than the UE maximum allowed output power, scaling-down is not applied to the UL control channels. Instead, the scaling-down is achieved by applying w2(i) which is a second weighting factor or a second scaling factor to transmission power of another channel (i.e., a UL data channel or an SRS) according to power remaining after subtracting the total transmission power sum of the UL control channels from the UE maximum allowed output power.

### II. Embodiments for Implementing Proposals Based on a Disclosure of the Present Specification

### II-1. Embodiment 1

A method based on the proposal 1 and a method based on the proposal 2 may be implemented according to the embodiment 1.

First, when a UL data channel is xPUSCH, transmission power of the xPUSCH may be determined as follows.

For xPUSCH transmission performed by a UE for a serving cell c in a subframe UE transmission power P_{xPUSCH,c}(i) may be determined as follows.

$${P}_{xPUSCH , c} ( i ) = min {\{ \begin{matrix}{P}_{CMAX , c} ( i ) , \\ \begin{matrix}10 {log}_{10} ( {M}_{xPUSCH , c} ( i ) ) + {P}_{O\_xPUSCH , c} ( j ) + \\ {α}_{c} ( j ) \cdot {PL}_{c} + {Δ}_{TF , c} ( i ) + {f}_{c} ( i )\end{matrix}\end{matrix} \}}_{[ dBm ]} \qquad [ Equation 6 ]$$

P_{CMAX,c}(i) is UE transmission power configured in the subframe i for the serving cell c.
M_{xPUSCH,c}(i) is a bandwidth of PUSCH resource assignment for the serving cell c in the subframe i, and is expressed as the number of resource blocks (RBs).
P_{O}_{_}_{xPUSCH,c}(j) is a parameter expressed as the sum of P_{O}_{_}_{NORMINAL}_{_}_{xPUSCH,c}(j) provided from a higher layer with respect to j=0 and j=1 and P_{O}_{_}_{UE}_{_}_{xPUSCH,c}(j) provided from the higher layer with respect to j=0 and j=1.
α_{c}(j) is any one of 0, 0.4, 0.5, 0.6, 0.7, 0.8, 0.9, and 1.
PL_{c} is a downlink path-loss estimation value calculated by the UE for the serving cell c, and is expressed in dB.
Δ_{TF,c}(i) is as follows.

Δ_{TF,c}(i)−10log₁₀((2^{BPRE·K}ₛ−1)β_{offset}^{PUSCH}) for Kₛ1.25.

Δ_{TF,c}(i)=0 for Kₛ=1.25.

Herein, Kₛ is a parameter provided by a higher layer.

BPRE=O_{CQI}/N_{RE}. O_{CQI} is the number of CQI/PMI bits including a CRC bit. N_{RE} is the number of resource elements.
δ_{PUSCH,c} is a UE-specific correction value.
f_{c}(i) is as follows.

f_{c}(i)=f_{c}(i−1)δ_{xPUSCH,c}(i−K_{xPUSCH})

f_{c}(i)=δ_{xPUSCH,c}(i−K_{xPUSCH})

Herein, δ_{xPUSCH,c}(i-K_{xPUSCH}) is signaled through DCI of xPDCCH in a subframe i-K_{xPUSCH}.

δ_{xPUSCH} is the number of subframes between transmission of xPDCCH with DCI and transmission of corresponding xPUSCH.

δ_{xPUSCH,c} is a dB absolute value signaled through DCI of xPDCCH.

Meanwhile, if a UL data channel (xPUSCH) and a UL control channel (xPUCCH) are time-domain multiplexed in a subframe i for a serving cell d, the xPUSCH transmission power P_{xPUSCH,d}(o) is derived as follows.

P_{xPUSCH,d}(i)=max{P′_{xPUSCH,d}(i),P′_{xPUCCH,d}(i)} [Equation 7]

Herein, P′_{xPUSCH,d}(i) is xPUSCH transmission power derived by Equation 5 above, and P′_{xPUCCH,d}(i) is xPUCCH transmission power derived as described below.

In a situation where UL carrier aggregation is configured, if total transmission power of the UE exceeds a threshold \hat{P}_{CMAX}(i), the UE scales xPUSCH transmission power \hat{P}_{xPUSCH,c}(i) without UCI for the serving cell c in the subframe i to satisfy the following condition.

$${\sum }_{c \neq d , j} w ( i ) \cdot {\hat{P}}_{x PUSCH , c} ( i ) \leq ( {\hat{P}}_{CMAX} ( i ) - {\sum }_{d} {\hat{P}}_{xPUSCH , d} ( i ) - {\sum }_{j} {\hat{P}}_{xPUSCH , j} ( i ) ) \qquad [ Equation 8 ]$$

Parameters used in Equation 8 are as follows.

\hat{P}_{xPUSCH,d}(i) is a linear value of P_{xPUSCH,d}(i) for the serving cell d.

\hat{P}_{xPUSCH,c}(i) is a linear value of transmission power P_{xPUSCH,c}(i) of xPUSCH without UCI for the serving cell c.

\hat{P}_{xPUSCH,i}(i) is a linear value of transmission power P_{PUSCH,j}(i) of xPUSCH with UCI for the serving cell j.

w(i) is a scaling value of \hat{P}_{xPUSCH,c}(i) for the serving cell c. Herein, 0≤w(i)≤1.

If there is no xPUCCH transmission for the serving cell d in the subframe i, \hat{P}_{xPUCCH,d}(i)=0.

If there is no xPUSCH transmission for the serving cell j in the subframe \hat{P}_{xPUSCH,j}(i)=0.

Values w(i) are the same for all xPUSCHs without UCI in the subframe i when w(i)>0 while w(i)=0 for a specific cell.

Next, when a UL control channel is xPUCCH, transmission power of the xPUCCH may be determined as follows.

For xPUCCH transmission performed by the UE for the serving cell c in the subframe i, UE transmission power P_{xPUCCH,c}(i) may be determined as follows.

$${P}_{xPUCCH , c} ( i ) = min {\{ \begin{matrix}{P}_{CMAX , c} ( i ) , \\ \begin{matrix}{P}_{0 \_xPUCCH , c} + {PL}_{c} + \\ {h}_{c} ( {n}_{CQI} , {n}_{BI} , {n}_{HARQ} , {n}_{SR} ) + \\ {Δ}_{F\_xPUCCH , c} ( F ) + {Δ}_{TxD} ( {F}^{′} ) + g ( i )\end{matrix}\end{matrix} \}}_{[ dBm ]} \qquad [ Equation 9 ]$$

Parameters in the above equation are as follows.
P_{CMAX,c}(i) is UE transmission power configured in the subframe i for the serving cell c.
Δ_{F}_{_}_{PUCCH}(F) is defined in a higher layer (RRC).
Δ_{TxD}(F′) is as follows. If the UE is configured by the higher layer to transmit a PUCCH for two antenna ports, a value Δ_{TxD}(F′) for each PUCCH format F′ is provided by the higher layer. Otherwise, Δ_{TxD}(F′)=0 without exception.
h(n_{CQI},n_{HARQ},n_{SR}) has a different value for each PUCCH format. Herein, n_{CQI} denotes the number of bits of channel quality information (CQI). In addition, if a scheduling request (SR) is configured in the subframe i and there is no SR configuration in any transmission block related to UL-SCH of the UE, n_{CR}=1, and otherwise, n_{SR}=0. If the UE is configured in one serving cell, n_{HARQ} is the number of HARQ-ACK bits transmitted in the subframe i. Detailed content thereof are the same as those in Equation 3 and Equation 4.
P_{O}_{_}_{PUCCH} is a parameter composed of a sum of a parameter P_{O}_{_}_{NOMINAL}_{_}_{PUCCH} and parameter P_{O}_{_}_{UE}_{_}_{PUCCH} provided by the higher layer.
δ_{xPUCCH,c} is a UE-specific correction value for the serving cell c.

Finally, when a UL control channel is xSRS, transmission power the xSRS may be determined as follows.

UE transmission power P_{xSRS,c} for the SRS transmitted in the subframe i for the serving cell c may be determined as follows.

P_{xSRS,c}(i)=min{P_{CMAX,c}(i),P_{xSRS}_{_}_{OFFSET,c}(m)+10log₁₀(M_{xSRS,c})+P_{O}_{_}_{xPUSCH,c}(j)+α_{c}(j)·PL_{c}+f_{c}(i)}[dBm] [Equation 10]

Parameters in Equation 8 above are as follows.
P_{CMAX,c}(i) is UE transmission power configured in the subframe i for the serving cell c.
P_{xSRS}_{_}_{OFFSET,C}(m) is a value semi-statically configured by a higher layer with respect to m=0 and m=1 for the serving cell c.
M_{xSRS,c} is a bandwidth of PUSCH resource assignment for the serving cell c in the subframe i, and is expressed as the number of resource blocks (RBs).
f_{c}(i) denotes a current xPUSCH power control adjustment state for the serving cell c.
P_{O}_{_}_{PUSCH,c}(j) and α_{c}(j) are the same as those described above for PUSCH transmission power.

Meanwhile, when UE total transmission power for the SRS exceeds \hat{P}_{CMAX}(i) on any OFDM symbol, the UE scales \hat{P}_{xSRS,c}(i) xSRS,c for the serving cell c in a corresponding OFDM symbol in the subframe i to satisfy the following condition.

$${\sum }_{c} w ( i ) \cdot {\hat{P}}_{xSRS , c} ( i ) \leq {\hat{P}}_{CMAX} ( i ) \qquad [ Equation 11 ]$$

Herein, \hat{P}_{xSRS,c}(i) is a linear value of P_{xSRS,c}(i). w(i) is a scaling factor value. Herein, 0≤w(i)≤1.

### II-2. Embodiment 1-A

A method based on the proposal 1 and a method based on the proposal 2 may be implemented according to the embodiment 1-A.

For xPUSCH transmission performed by a UE for a serving cell c in a subframe UE transmission power P_{xPUSCH,c}(i) may be determined by Equation 6 above.

Meanwhile, when xPUSCH and xPUCCH are time-domain multiplexed for a serving cell d in the subframe i, transmission power P_{d}^{aligned}(i) for xPUCCH and xPUSCH is set to a maximum value between P_{xPUSCH,d}(i) and P_{xPUCCH,d}(i).

In a situation where UL carrier aggregation is configured, if the UE transmits xPUSCH with UCI for a serving cell j in the subframe i and xPUSCH and xPUCCH are time-domain multiplexed in the subframe i, and if total transmission power of the UE exceeds \hat{P}_{CMAX}(i) the UE scales xPUSCH without UCI for the serving cell c in the subframe i to satisfy the following condition.

$${\sum }_{c \neq d , j} w ( i ) \cdot {\hat{P}}_{x PUSCH , c} ( i ) \leq ( {\hat{P}}_{CMAX} ( i ) - {\sum }_{d} {\hat{P}}_{d}^{aligned} ( i ) - {\sum }_{j} {\hat{P}}_{xPUSCH , j} ( i ) ) \qquad [ Equation 12 ]$$

Herein, \hat{P}_{d}^{aligned}(i) is a linear value of P_{d} (i).

Other parameters are the same as the parameters of Equation 8.

Next, for xPUCCH transmission performed by the UE for the serving cell c in the subframe i, UE transmission power P_{xPUCCH,c}(i) may be determined by Equation 9 above.

Finally, UE transmission power P_{xSRS,c} for an SRS transmitted in the subframe i for the serving cell c may be determined as described in Equation 10 above.

### II-3. Embodiment 1-B

As a method modified from the method based on the proposal 1 and the method based on the proposal 2 and the method of the embodiment 1 and embodiment 1-A to which these methods are applied, a UL data channel in which UCI is piggybacked on the UL data channel as in a type B among types of the UL data channel (xPUSCH) of the proposal 1 may apply transmission power scaling as in a type C. An embodiment related thereto is proposed below as the embodiment 1-B.

For xPUSCH transmission performed by a UE for a serving cell c in a subframe UE transmission power P_{xPUSCH,c}(i) may be determined by Equation 6 above.

Meanwhile, when xPUSCH and xPUCCH are time-domain multiplexed for a serving cell d in the subframe i, transmission power P_{d}^{aligned}(i) for xPUCCH and xPUSCH is set to a maximum value between P_{xPUSCH,d}(i) and P_{xPUCCH,d}(i).

In a situation where UL carrier aggregation is configured, if the UE transmits xPUSCH with UCI for a serving cell j in the subframe i and xPUSCH and xPUCCH are time-domain multiplexed in the subframe i, and if total transmission power of the UE exceeds \hat{P}_{CMAX}(i), the UE scales xPUSCH without UCI for the serving cell c in the subframe i to satisfy the following condition.

$${\sum }_{c \neq d} w ( i ) \cdot {\hat{P}}_{x PUSCH , c} ( i ) \leq ( {\hat{P}}_{CMAX} ( i ) - {\sum }_{d} {\hat{P}}_{d}^{aligned} ( i ) ) \qquad [ Equation 13 ]$$

Parameters used in Equation 13 are the same as the parameters of Equation 8.

Next, for xPUCCH transmission performed by the UE for the serving cell c in the subframe i, UE transmission power P_{xPUCCH,c}(i) may be determined by Equation 9 above.

Finally, UE transmission power P_{xSRS,c} for an SRS transmitted in the subframe i for the serving cell c may be determined as described in Equation 10 above.

### II-4. Embodiment 2

A method based on the proposal 2 and a method based on the proposal 3 may be implemented according to the embodiment 2.

For xPUSCH transmission performed by a UE for a serving cell c in a subframe UE transmission power P_{xPUSCH,c}(i) may be determined by Equation 6 above.

In a situation where UL carrier aggregation is configured, the UE transmits xPUSCH with UCI for a serving cell j in the subframe i and xPUSCH and xPUCCH are time-domain multiplexed in the subframe i, and if total transmission power of the UE exceeds \hat{P}_{CMAX}(i) the UE scales xPUSCH without UCI for the serving cell c in the subframe i to satisfy the following condition.

$${\sum }_{c \neq d , j} w ( i ) \cdot {\hat{P}}_{x PUSCH , c} ( i ) \leq ( {\hat{P}}_{CMAX} ( i ) - {\sum }_{d} {\hat{P}}_{xPUSCH , d}^{′} ( i ) - {\sum }_{j} {\hat{P}}_{xPUSCH , j} ( i ) ) \qquad [ Equation 14 ]$$

Parameters used in Equation 14 are the same as the parameters of Equation 8.

\hat{P}′_{xPUSCH,,d} (i) for xPUSCH to be multiplexed with PUCCH for the serving cell d in the subframe i is obtained as follows.

\hat{P}′_{xPUSCH,d}(i)=max{\hat{P}_{xPUSCH,d}(i),\hat{P}_{xPUCCH,d}(i)} [Equation 15]

Parameters used in Equation 15 are the same as the parameters of Equation 8.

Next, for xPUCCH transmission performed by the UE for the serving cell c in the subframe i, UE transmission power P_{xPUCCH,c}(i) may be determined by Equation 9 above.

Finally, UE transmission power P_{xSRS,c} for an SRS transmitted in the subframe i for the serving cell c may be determined as described in Equation 10 above.

### II-5. Embodiment 2-A

As a method modified from the method based on the proposal 2 and the method based on the proposal 3 and the method of the embodiment 2 to which these methods are applied, a UL data channel in which UCI is piggybacked on the UL data channel as in a type B among types of the UL data channel (xPUSCH) of the proposal 1 may apply transmission power scaling as in a type C. An embodiment related thereto is proposed below as the embodiment 2-A.

For xPUSCH transmission performed by a UE for a serving cell c in a subframe UE transmission power P_{xPUSCH,c}(i) may be determined by Equation 6 above.

In a situation where UL carrier aggregation is configured, the UE transmits xPUSCH with UCI for a serving cell j in the subframe i and xPUSCH and xPUCCH are time-domain multiplexed in the subframe i, and if total transmission power of the UE exceeds \hat{P}_{CMAX}(i), the UE scales xPUSCH without UCI for the serving cell c in the subframe i to satisfy the following condition.

$${\sum }_{c \neq d} w ( i ) \cdot {\hat{P}}_{x PUSCH , c} ( i ) \leq ( {\hat{P}}_{CMAX} ( i ) - {\sum }_{d} {\hat{P}}_{xPUSCH , d}^{′} ( i ) ) \qquad [ Equation 16 ]$$

Parameters used in Equation 16 are the same as the parameters of Equation 8.

\hat{P}_{xPUSCH,d}(i) for xPUSCH to be multiplexed with PUCCH for a serving cell d in the subframe i is obtained by Equation 15.

Next, for xPUCCH transmission performed by the UE for the serving cell c in the subframe i, UE transmission power P_{xPUCCH,c}(i) may be determined by Equation 9 above.

Finally, UE transmission power P_{xSRS,c} for an SRS transmitted in the subframe i for the serving cell c may be determined as described in Equation 10 above.

### II-6. Embodiment 2-B

A method based on the proposal 4 may be implemented according to the embodiment 2-B.

First, for xPUSCH transmission performed by a UE for a serving cell c in a subframe UE transmission power P_{xPUSCH,c}(i) may be determined by Equation 6 above.

Next, for xPUCCH transmission performed by the UE for the serving cell c in the subframe i, UE transmission power P_{xPUCCH,c}(i) may be determined by Equation 9 above.

Finally, UE transmission power P_{xSRS,c} for an SRS transmitted in the subframe i for the serving cell c may be determined as described in Equation 10 above.

Meanwhile, when UL carrier aggregation is configured, if total transmission power exceeds \hat{P}_{CMAX}(i) in any OFDM symbol without xPUCCH for any serving cell in the subframe i, the UE may scale transmission power for all physical channels as follows by using a scaling factor v(i) on all symbols without xPUCCH. Herein, \hat{P}_{CMAX}(i) is a linear value of UE total configured maximum output power P_{CMAX}.

For each of OFDM symbols without xPUCCH, the UE calculates the total transmission power by summing transmission power for all physical channels of all cells on the symbol.

The UE calculates a maximum value of per-symbol total transmission power values on the OFDM symbols.

The UE calculates the scaling factor v(i) so that the maximum value of the total transmission power in the symbol is equal to or less than \hat{P}_{CMAX}(i). Herein, the value v(i) is the same value for all cells when v(i)>0. However, for a specific cell, v(i)=0.

If total transmission power exceeds \hat{P}_{CMAX}(i) in an OFDM symbol with xPUCCH for any serving cell in the subframe i, the UE scales transmission power for the physical channels on the OFDM symbol as follows or configures the transmission power to 0.

$$If {\sum }_{j ∈ xPUCCHCells} {\hat{P}}_{xPUCCH , j} ( i ) \leq {\hat{P}}_{CMAX} ( i ) , \\ then {\sum }_{c ∉ j} w ( i ) \cdot ( {\hat{P}}_{xPUSCH , c} ( i ) + {\hat{P}}_{xSRS , c} ( i ) ) \leq ( {\hat{P}}_{CMAX} ( i ) - {\sum }_{j ∈ xPUCCHCells} {\hat{P}}_{xPUCCH , j} ( i ) ) \\ Else {\sum }_{j ∈ xPUCCHCells} w ( i ) \cdot {\hat{P}}_{xPUCCH , j} ( i ) \leq {\hat{P}}_{CMAX} ( i ) , \\ and {\hat{P}}_{xPUSCH , c} ( i ) , \qquad [ Equation 17 ]$$

\hat{P}_{xSRS,c}(i) for the serving cell c∉j in that symbol is set to zero.

Herein, xPUCCHCells is a set of cells to which xPUCCH is to be transmitted. Each related cell is expressed by j.

Parameters used in the above equation may be understood by referring to the parameters used in Equation 8 to Equation 11.

### III-7. Embodiment 3

A method of boosting lower transmission power so that a transmission power difference between channels is applied to be equal to or less than a threshold on any transmission frequency carrier as in the proposal 1 and a method of applying a maximum value between a transmission power value of a UL data channel and a transmission power value of a UL control channel on power scaling as in the proposal 3 may be applied, and a weighting factor for power scaling in a subframe may be fixed. This is an embodiment 3.

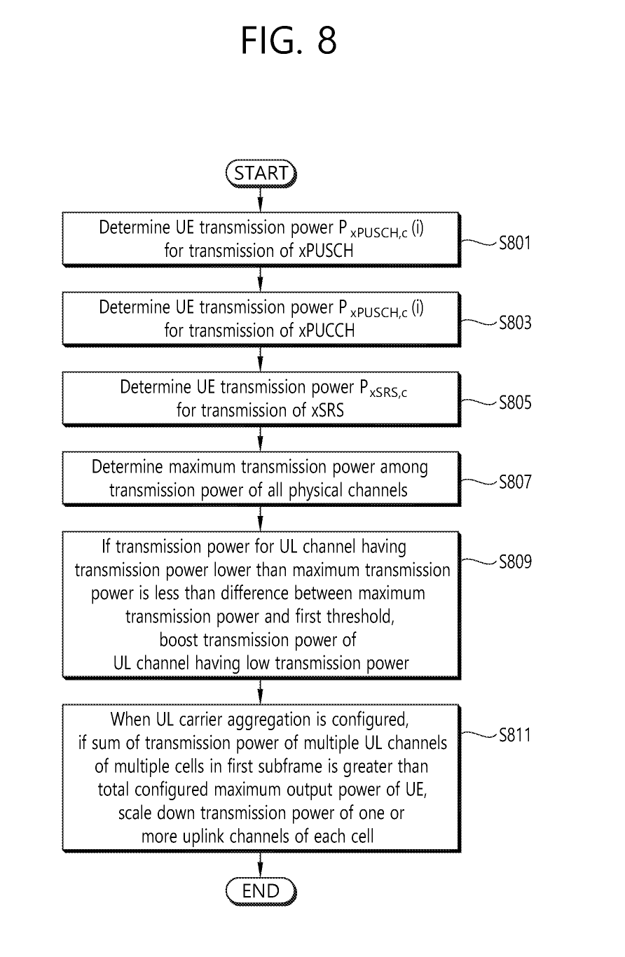

FIG. 8 is a flowchart showing a procedure according to the embodiment 3.

First, for xPUSCH transmission performed by a UE for a serving cell c in a subframe i, UE transmission power P_{xPUSCH,c}(i) may be determined by Equation 6 above (S801).

Next, with respect to xPUCCH transmission for the serving cell c in the subframe i, the UE may determine UE transmission power P_{xPUCCH,c}(i) as shown in Equation 9 described above (S803).

Next, the UE may determine UE transmission power P_{xSRS,c} for an SRS transmitted in the subframe i for the serving cell c as described in Equation 10 above (S805).

In addition, the UE determines maximum transmission power among transmission power of all physical channels transmitted to the serving cell c as follows (S807).

P_{max,c}(i)=max{P_{xPUSCH,c}(i),P_{xPUCCH,c}(i),P_{xSRS,c}(i)}tm [Equation 18]

Herein, a value for a channel which is not transmitted among P_{xPUSCH,c}(i), P_{xPUCCH,c}(i), and P_{xSRS,c}(i) may be 0.

If transmission power for a UL channel having transmission power lower than the maximum transmission power is less than a difference between the maximum transmission power and a threshold (e.g., X), low transmission power of a UL channel is boosted (or scaled up) (S809).

That is, the UE adjusts (boosts or scales up) transmission power of each physical channel transmitted to the serving cell c to satisfy the following condition.

If P_{xPUSCH,c}(i)<P_{max,c}(i)−X then P_{xPUSCH,c}(i)=P_{max,c}(i)−X

If P_{xPUCCH,c}(i)<P_{max,c}(i)−X then P_{xPUCCH,c}(i)=P_{max,c}(i)−X

If P_{xSRS,c}(i)<P_{max,c}(i)−then P_{xSRS,c}(i)=P_{max,c}(i)−X [Equation 19]

Herein, X is a threshold expressed in dB. The threshold X may be as follows.

Option # A: It is set by higher layer signaling

Option # B: It is set to a predetermined value

Option # C: The UE arbitrarily sets a value X

Meanwhile, when UL carrier aggregation is configured, the UE first adjusts per-cell transmission power for all physical channels as described above.

Transmission power of one or more uplink channels for each cell is scaled down if a total sum of transmission power of multiple uplink channels for multiple cells in the first subframe is greater than total configured maximum output power of the UE (S811).

That is, if total transmission power

$${\sum }_{c} {\hat{P}}_{max , c} ( i )$$

exceeds \hat{P}_{CMAX}(i) in a subframe i, transmission power for physical channels is scaled to satisfy the following condition or is set to 0.

First, if

$${\sum }_{j ∈ xPUCCHCells} {\hat{P}}_{max , j} ( i ) \leq {\hat{P}}_{CMAX} ( i )$$

is satisfied, w(i) is calculated by an equation based on any one option, i.e., any one of Equation 20 based on the option 1 and Equation 21 based on the option 2.

$$w ( i ) \cdot max \{ \begin{matrix}{\sum }_{d ∉ xPUCCHCells} {\hat{P}}_{xPUSCH , d} ( i ) , \\ {\sum }_{d ∉ xPUCCHCells} {\hat{P}}_{xSRS , d} ( i )\end{matrix} \} \leq ( {\hat{P}}_{CMAX} ( i ) - {\sum }_{j ∈ xPUCCHCells} {\hat{P}}_{max , j} ( i ) ) \qquad [ Equation 20 ]$$

Herein, for all cells satisfying d∉xPUCCHCells, \hat{P}_{xPUSCH,d}(i) and \hat{P}_{xSRS,d}(i) are scaled based on w(i).

$$w ( i ) \cdot {\sum }_{j ∉ xPUCCHCells} max \{ {\hat{P}}_{xPUSCH , d} ( i ) , {\hat{P}}_{xSRS , d} ( i ) \} \leq ( {\hat{P}}_{CMAX} ( i ) - {\sum }_{j ∈ xPUCCHCells} {\hat{P}}_{max , j} ( i ) ) \qquad [ Equation 21 ]$$

Herein, for all cells satisfying d∉xPUCCHCells, \hat{P}_{xPUSCH,d}(i) and \hat{P}_{xSRS,d}(i) are scaled based on w(i).

However, if

$${\sum }_{j ∈ xPUCCHCells} {\hat{P}}_{max , j} ( i ) \leq {\hat{P}}_{CMAX} ( i )$$

is not satisfied, w(i) is selected as shown in Equation 22 below.

$${\sum }_{j ∈ xPUCCHCells} w ( i ) \cdot {\hat{P}}_{max , j} ( i ) \leq {\hat{P}}_{CMAX} ( i ) \qquad [ Equation 22 ]$$

Herein, for all cells satisfying j∉xPUCCHCells, \hat{P}_{xPUSCH,}(i) and \hat{P}_{xPUCCH,j}(i) are scaled based on w(i). For cells satisfying d∉xPUCCHCells, \hat{P}_{xPUSCH,d}(i) and \hat{P}_{xSRS,d}(i) are set to 0.

Herein, xPUCCHCells is a set of cells to which xPUCCH is to be transmitted. Each related cell is expressed by j.

Parameters used in the above equation may be understood by referring to the parameters used in Equation 8 to Equation 11.

The aforementioned embodiments of the present invention can be implemented through various means. For example, the embodiments of the present invention can be implemented in hardware, firmware, software, combination of them, etc. Details thereof will be described with reference to the drawing.

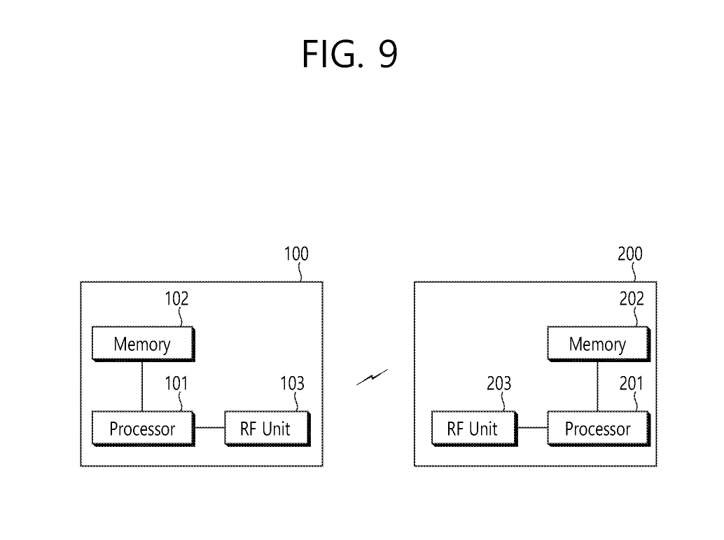

FIG. 9 is a block diagram showing a wireless communication system for implementing a disclosure of the present specification.

A BS 200 includes a processor 201, a memory 202, and a radio frequency (RF) unit 203. The memory 202 is coupled to the processor 201, and stores a variety of information for driving the processor 201. The RF unit 203 is coupled to the processor 201, and transmits and/or receives a radio signal. The processor 201 implements the proposed functions, procedures, and/or methods. In the aforementioned embodiment, an operation of the BS may be implemented by the processor 201.

A UE 100 includes a processor 101, a memory 102, and an RF unit 103. The memory 102 is coupled to the processor 101, and stores a variety of information for driving the processor 101. The RF unit 103 is coupled to the processor 101, and transmits and/or receives a radio signal. The processor 101 implements the proposed functions, procedures, and/or methods.

The processor may include Application-specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method of determining transmission power of an uplink channel, the method comprising:
selecting maximum transmission power from among transmission power for multiple uplink channels transmitted to any serving cell in a first subframe; and
when transmission power for a first uplink channel having lower transmission power than the maximum transmission power is less than a difference between the maximum transmission power and a first threshold, determining boosting of transmission power of the first uplink channel,
wherein the multiple uplink channels comprise one or more of an uplink data channel, an uplink control channel, and an uplink reference signal.

2. The method of claim 1, wherein transmission power for the first channel is determined to be boosted by the difference between the maximum transmission power and the first threshold.

3. The method of claim 1,
wherein the uplink data channel is a physical uplink shared channel (PUSCH),
wherein the uplink control channel is a physical uplink control channel (PUCCH), and
wherein the uplink reference signal is a sounding reference signal (SRS).

4. The method of claim 1, wherein the first threshold is received through an uplink signal or is predetermined or is determined by a terminal.

5. The method of claim 1, further comprising, when uplink carrier aggregation is configured, scaling down transmission power of one or more uplink channels for each cell if a total sum of transmission power of multiple uplink channels for multiple cells in the first subframe is greater than total configured maximum output power of a terminal.

6. The method of claim 5, wherein if the total sum of transmission power of the uplink control channels for the multiple cells is less than the total configured maximum output power of the terminal, the one or more uplink channels to be scaled down comprise the uplink data channel and the uplink reference signal.

7. The method of claim 6, wherein if the total sum of transmission power of the uplink control channels for the multiple cells is greater than the total configured maximum output power of the terminal, the one or more uplink channels to be scaled down comprise the uplink control channel and the uplink data channel.

8. A terminal for determining transmission power of an uplink channel, the terminal comprising:
a transceiver; and
a processor controlling the transceiver, wherein the processor is configured to:
select maximum transmission power from among transmission power for multiple uplink channels transmitted to any serving cell in a first subframe; and
when transmission power for a first uplink channel having lower transmission power than the maximum transmission power is less than a difference between the maximum transmission power and a first threshold, determine boosting of transmission power of the first uplink channel,
wherein the multiple uplink channels comprise one or more of an uplink data channel, an uplink control channel, and an uplink reference signal.

9. The terminal of claim 8, wherein transmission power for the first channel is determined to be boosted by the difference between the maximum transmission power and the first threshold.

10. The terminal of claim 8,
wherein the uplink data channel is a physical uplink shared channel (PUSCH),
wherein the uplink control channel is a physical uplink control channel (PUCCH), and
wherein the uplink reference signal is a sounding reference signal (SRS).

11. The terminal of claim 8, wherein the first threshold is received through an uplink signal or is predetermined or is determined by the terminal.

12. The terminal of claim 8, wherein the processor is configured to, when uplink carrier aggregation is configured, scale down transmission power of one or more uplink channels for each cell if a total sum of transmission power of multiple uplink channels for multiple cells in the first subframe is greater than total configured maximum output power of a terminal.

13. The terminal of claim 12, wherein if the total sum of transmission power of the uplink control channels for the multiple cells is less than the total configured maximum output power of the terminal, the one or more uplink channels to be scaled down comprise the uplink data channel and the uplink reference signal.

14. The terminal of claim 12, wherein if the total sum of transmission power of the uplink control channels for the multiple cells is greater than the total configured maximum output power of the terminal, the one or more uplink channels to be scaled down comprise the uplink control channel and the uplink data channel.
